(19) United States
(12) Patent Application Publication
(10) Pub. No.: US 2013/0304705 A1
(43) Pub. Date: Nov. 14, 2013

(54) MIRROR FILE SYSTEM

(71) Applicant: Twin Peaks Software, Inc., Fremont, CA (US)

(72) Inventor: John P. WONG, Fremont, CA (US)

(73) Assignee: Twin Peaks Software, Inc., Fremont, CA (US)

(21) Appl. No.: 13/892,582

(22) Filed: May 13, 2013

Related U.S. Application Data
(60) Provisional application No. 61/646,217, filed on May 11, 2012.

(51) Int. Cl. G06F 17/30

(52) U.S. Cl. CPC G06F 17/30129
USPC 707/655

(57) ABSTRACT

A mirror file system (MFS) is a virtual file system that links two or more folders (e.g., on Windows) or directories (e.g., on UNIX) to form a mirroring pair. The folders or directories can reside on a local memory device of a computing system, on a portable memory device, or in a folder or directory shared by a remote system. A graphical user interface (GUI) or user application creates or opens a file in the Active folder, and the MFS software module creates or opens the same file in a Passive folder which is not mounted on the same mount point as the Active folder. The Active folder receives a file operation from the application of the computer directly. Once the file operation is received by the Active folder, it is automatically replicated to the Passive folder. The MFS software module provides update options of sequential, parallel synchronous and asynchronous.

### FIELD

The present disclosure relates to a mirror file system (MFS) which is a virtual file system that links two or more folders or directories to form a mirroring pair.

### BACKGROUND

In a computer network environment, hundreds or even thousands of computer systems may be connected by a communication channel, such as a network. The computer systems can all communicate with each other through many different communication protocols. To help the systems cooperate more closely, resource sharing mechanisms have been developed to allow computer systems to share files across the computer network. One example of such a mechanism is the client-server Network File System (NFS) developed by Sun Microsystems. By sharing the files across the network, every client system on the network can access the shared files as if the files were local files on the client system, although the files may be physically located on and managed by a network server system at a remote location on the network. Multiple network servers can be implemented on the network, such as a server for each sub-network. Each network server contains a copy of the shared files on its storage device and shares them across the network. This arrangement works successfully as long as every copy of the files is identical and all copies are updated in real time whenever an update occurs to one copy.

In order for a physical file system that resides on a storage device (e.g., a local and/or external hard drive) of a computer system to be accessible by an application of the computer system, the physical file system must first be mounted on a mount point, for example, a directory, by the file system software module of the computer system. Once the file system is mounted, the application can access the files and directories on that file system through the mount point. All file systems and operating systems developed until now allow only one file system to be mounted on a given mount point. Even if one manages to mount a new file system on a mount point that already has a file system mounted on it, the previously mounted file system will be hidden and inaccessible. That is, only the most recently mounted file system can be accessed through the mount point.

U.S. Pat. No. 7,418,439 to Wong discloses a mirror file system (MFS) for mounting multiple file systems on a single directory and linking them to form a mirroring pair. Thus, U.S. Pat. No. 7,418,439 overcame the above-described restriction of allowing only one file system to be mounted on a mount point, by enabling two or more file systems to be mounted under a single mount point in a physical file system. All file systems mounted by MFS on a single mount point are linked together to form a mirroring pair (for two file systems on a mount point) or mirroring clusters (for multiple file systems on a mount point). When an application updates files and directories on that single mount point, all file systems mounted under it receive the same updates in real time. This technique provides a simple and easy way for applications to mirror files between or among several file systems through a single mount point. It also provides a convenient way for system administrators to manage all members of mirroring clusters. In U.S. Pat. No. 7,418,439, the two file systems to be linked to form a mirroring pair must, however, be mounted under a single mount point. The entire disclosure of U.S. Pat. No. 7,418,439 is incorporated herein by reference in its entirety.

### SUMMARY

Exemplary embodiments of the present disclosure provide a new technique in which in the MFS file system software module links and mirrors file systems that are not mounted under a single mount point. The exemplary embodiments of the present disclosure enable two file systems mounted on two or more separate mount points to be linked and mirrored.

In accordance with an exemplary embodiment, the MFS is a virtual file system that links two or more folders (e.g., on Windows) or directories (e.g., on UNIX) to form a mirroring pair. The folders or directories can reside on a local computer-readable recording medium of a computing system (e.g., a hard disk), on a portable memory device such as a Flash memory or USB drive, or in a folder or directory shared by a remote system, for example, on “My Network” or “Network Place”. A graphical user interface (GUI) or user application creates or updates a file in the Active folder, and MFS creates or updates the same file in a Passive folder. As used herein, an “Active folder” or “Active directory” is the folder or directory which receives a file operation (e.g., update, create, delete) from the application of the computer directly. Once the file operation is received by the Active folder, the same file operation is replicated to the Passive folder or directory. As used herein, a “Passive folder” or “Passive directory” is a folder or directory in which a file is automatically modified or created by the MFS based on the file operation in the Active file or directory, but the Passive folder or directory does not receive the file operation from the application directly. In other words, the Passive folder or directory can only passively receive the file operation from the Active folder; it does not receive the file operation from the application directly and hence cannot send or replicate the file operation to the Active folder.

In accordance with an exemplary embodiment, there can be three update options: sequential, parallel synchronous, and asynchronous. With the MFS, a computer can keep a live backup copy of a file on its native storage, on an external storage device, or on a storage device that is attached to a remote system (e.g., the storage device of a remote server). In each case, both copies of a given file remain live and accessible. If one copy is lost or damaged for any reason, such as during a system failure or natural disaster, or because of human error, the other copy remains available. A disastrous loss of data of a file or access to it can thus be prevented.

### BRIEF DESCRIPTION OF THE DRAWINGS

Additional refinements, advantages and features of the present disclosure are described in more detail below with reference to exemplary embodiments illustrated in the drawings

FIG. 1 illustrates a block diagram of components of the architecture of a mirror file system (MFS) in the UNIX operating system, according to an exemplary embodiment of the present disclosure.

FIG. 2 illustrates a block diagram of components of the architecture of a MFS in the Windows operating system, according to an exemplary embodiment of the present disclosure.

FIG. 3 illustrates a block diagram of features of the MFS implementing a create post-callback operation, according to an exemplary embodiment of the present disclosure.

FIG. 4 illustrates a block diagram of features of the MFS implementing a write pre-callback operation, according to an exemplary embodiment of the present disclosure.

### DETAILED DESCRIPTION

In the following description of exemplary embodiments of the present disclosure, features of the present disclosure are explained with regard to the functions they perform in the MFS of the present disclosure. It is to be understood that a “computer” or “computer system” refers to a computer processing device (e.g., a computer, server, tablet computer, smart phone, etc.) having one or more processors executing computer programs and/or instructions recorded on non-transitory computer-readable recording mediums (e.g., local or external non-volatile memory such as ROM, hard disk drives, flash memory, etc.) for carrying out the operative functions described herein. Furthermore, the terms “memory” or “storage device” refer to such non-transitory computer-readable recording medium, and the term “application” or “application program” refers to an computer program tangibly recorded on the memory or storage device of the computer and executed by the one or more processors of the computer. The one or more processors of the computer may be a general-purpose processor such as an Intel® Core®, Pentium® or Celeron® processor or an AMD® Phenom®, Athlon® or Opteron® processor, or an application specific processor such as an application-specific integrated circuit (ASIC) that is configured to execute the operating system and applications recorded on the local and/or external storage devices of the computer.

In accordance with an exemplary embodiment, the MFS is a virtual file system that links two or more folders (e.g., on Windows) or directories (e.g., on UNIX) to form a mirroring pair. The folders or directories can reside on a local computer-readable recording medium of a computing system (e.g., a hard disk), on a portable memory device such as a Flash memory or USB drive, or in a folder or directory shared by a remote system, for example, on “My Network” or “Network Place”. A graphical user interface (GUI) or user application creates or updates a file in the Active folder, and MFS creates or updates the same file in a Passive folder. As used herein, an “Active folder” or “Active directory” is the folder or directory which receives a file operation (e.g., update, create, delete) from the application of the computer directly. Once the file operation is received by the Active folder, the same file operation is replicated to the Passive folder or directory. As used herein, a “Passive folder” or “Passive directory” is a folder or directory in which a file is automatically modified or created by the MFS based on the file operation in the Active file or directory, but the Passive folder or directory does not receive the file operation from the application directly. In other words, the Passive folder or directory can only passively receive the file operation from the Active folder; it does not receive the file operation from the application directly and hence cannot send or replicate the file operation to the Active folder.

Sequential mirroring was discussed in U.S. Pat. No. 7,418,439 MFS. The present disclosure provides how the MFS can also implement parallel, synchronous, and asynchronous mirroring to further enhance performance.

In both the UNIX and Microsoft Windows operating systems, file system design has progressed to the point where file systems can be mounted automatically as soon as their presence is detected. This capability is called automounting, or automount. For example, when a USB drive is connected, its file system is mounted automatically, without the need for intervention by a system administrator.

On UNIX systems, the Network File System (NFS) can be mounted automatically on the /net directory. On Windows, shared folders on a remote server can be mounted automatically on the “My Network” or “Network Place” folder after some setup procedure.

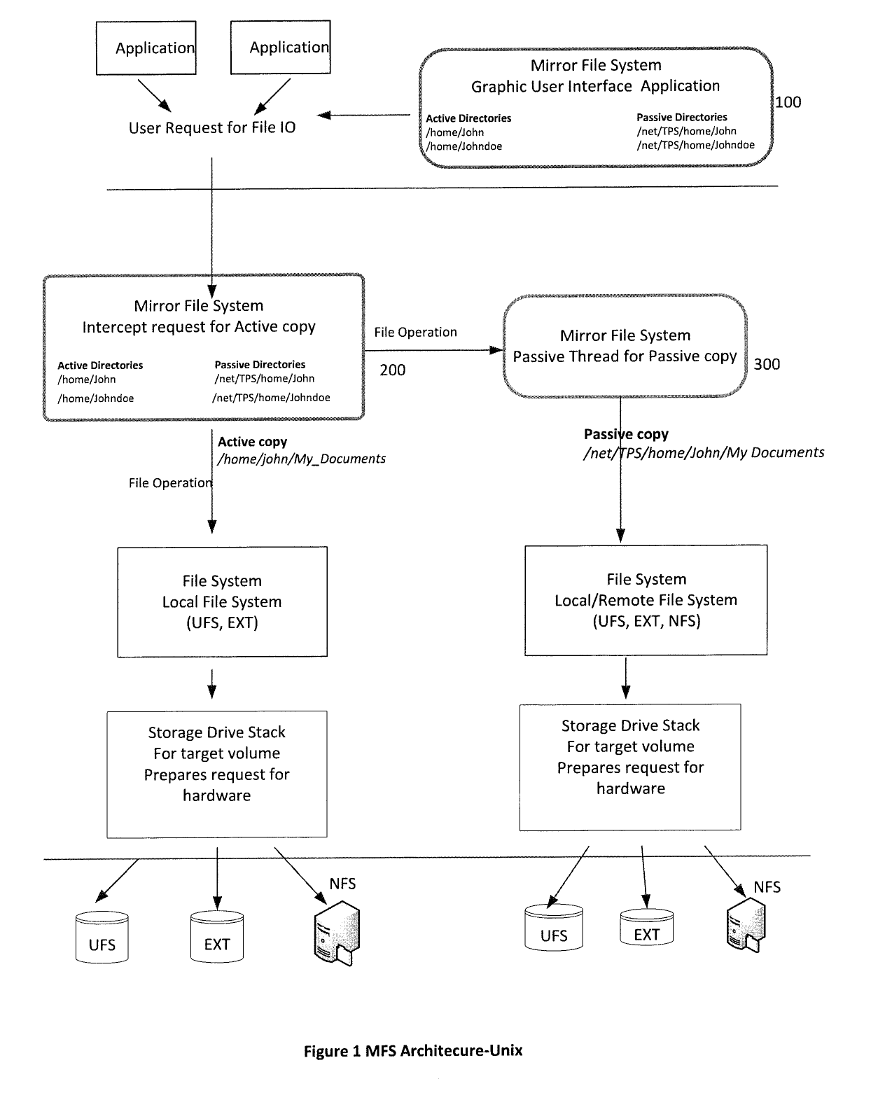

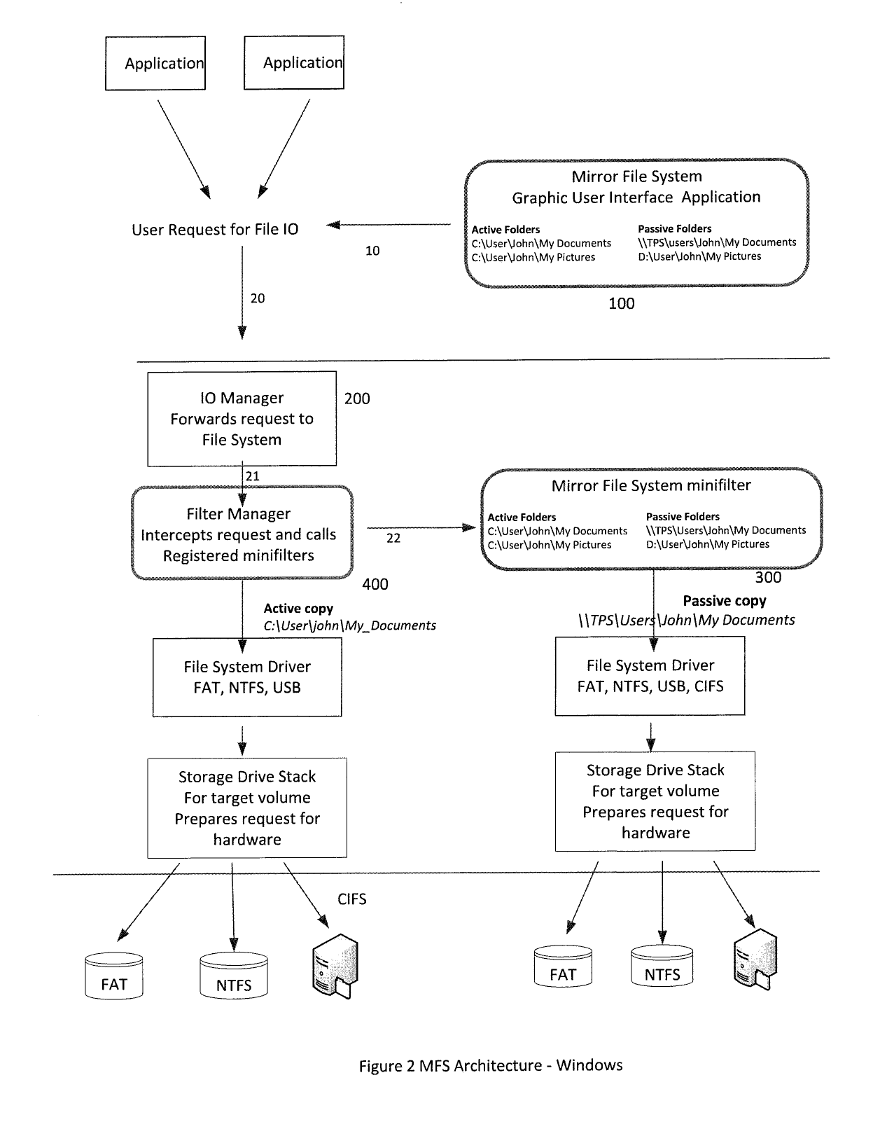

The automount functionality makes file systems easier to use and to access, and it eliminates the need to mount them manually under a single mount point. File systems that have been automounted under different mount points, however, can neither be linked to form mirroring pairs nor accessed from a single mount point. Wong's new methods, discussed here, enable two or more file systems that have been mounted on separate mount points to be linked as mirroring pair or mirroring cluster. Wong's methods are based on two software modules, a Mirror File System Graphic User Application (Box 100 in FIG. 1) and a Mirror File System software module (Box 200 and 300 in FIG. 1 for Unix, Box 300 in FIG. 2 for Windows).

### 1. Mirror File System Graphic User Interface (GUI) Application

In U.S. Pat. No. 7,418,439, two file systems to be linked to form a mirroring pair must be mounted under a single mount point.

With automount, all file systems are mounted automatically on a fixed directory or folder, either under the /net directory in UNIX or under \My Network folder in Windows. Because the file systems are mounted automatically on separate mount points, it would be redundant to mount them again manually under a single mount point. But to enable MFS mirroring functionality—by linking file systems mounted on separate mount points to form mirroring pairs or clusters—a new application is needed.

The application of the present disclosure can be implemented as a standalone application or as a graphic user interface (GUI) application program (e.g., Box 100, FIGS. 1 and 2), set to start manually or automatically when the user logs on. The user selects, from the folders that can be accessed on the local drive (e.g., the “C” drive), the USB drive, or the /net automount directory or “Network Place” folder, one folder as the Active folder and another as the Passive folder. These folders can reside on different file systems, such as EXT and NFS for UNIX, and NTFS, FAT, USB, or CIFS for Windows.

The following tables contrast the syntax for two mirroring pairs set up for one-to-one mirroring in UNIX and Windows syntax.

TABLE 1
Syntax for Two Mirroring Pairs in UNIX

| Active Directories(folders) | Passive Directories(folders) |
|---|---|
| /home/John | /net/TPS/home/John |
| /home/Johndoe | /net/TPS/home/Johndoe |

TABLE 2
Syntax for Two Mirroring Pairs in Windows

| Active Folders | Passive Folders |
|---|---|
| C:\Users\John\My Documents | \\TPS\users\John\My |
| | Documents |
| C:\User\John\My Pictures | D:\User\John\My Pictures |

In one-to-one mirroring, a mirroring pair has one Active folder and one Passive folder. An Active folder can also be linked to several Passive folders to enable one-to-many mirroring. One-to-many mirroring is also known as clustering.

The mirroring pair table is stored in a configuration file and is also sent and stored to the MFS file system software module.

At the start, the MFS GUI application program (e.g., Box 100, FIGS. 1 and 2) prompts the user to select Active and Passive folders from the local drives or /net directory (in UNIX) or \Network Places (in Windows), after which the MFS saves this information to the mirroring pair table in the configuration file and sends the table to the MFS file system software module.

If a mirroring pair has already been set up and saved, the MFS GUI application program reads the mirroring pair table from the user's configuration file and sends it to the MFS file system software module, as described above.

The user can also add new mirroring pairs, delete old ones from the configuration file, and configure multiple mirroring pairs on a system.

The data flow, depicted in FIG. 2, is as follows:

1. The MFS GUI application program (100) performs the following two steps to set up a mirroring pair table:
a. Read the mirroring pair table from the user's configuration file if it already exists, and
b. Prompt the user to select Active and Passive folders from folders that can be accessed from the system.

2. The MFS GUI application program (100) then save the mirroring pairs table to a configuration file and sends it to Mirror File System Mini Filter (300).

### 2. MFS File System Software Module

Although the principles and results are the same, MFS software module is implemented in slightly different ways in UNIX and Window to account for differences in architecture and nomenclature.

### 3. UNIX

In UNIX, the MFS software module is loaded and mounted on the Active directory. Once the Active directory is mounted, MFS software module controls all access to the directory and its sub-tree components, such as subdirectories and files. The root directory of a newly mounted MFS is the Active directory. The MFS software module uses a mirroring pair table to store entries either sent by the MFS GUI application program or input directly from the configuration file described in [0022], and it uses the mirroring pair table to identify an Active directory's corresponding Passive directory or directories.

### 4. Windows

In Windows, the MFS software module is implemented as a mini-filter file system driver (Box 300, FIG. 2) that is loaded into the system. The MFS software module intercepts file operations, matches them with the entries in the mirroring table, and processes them accordingly.

### 5. Operation

The MFS GUI application program starts when the user logs in. It reads the information from the configuration file and sends the mirroring pair table information to the MFS software module.

At run time, in order to access a file or folder, an application program resident on the computer that creates, reads and/or writes to a file calls the Create/Open function of the file or folder. When the MFS software module receives or intercepts a Create/Open call, its file Create/Open function checks the path name of the file or folder to be created or opened against the mirroring table to see if there is a match. A match indicates that the file to be created or opened is in the Active folder. If it finds a match, the MFS software module replicates the Create/Open operation on the same file in the Passive folder. After the files or folders are created/opened on both Active and Passive folders, MFS software module then links the files or folders, one Active and one Passive as a mirroring pair even though, in this case, they are mounted on different mount points.

### 6. File System Software Module to Link Active and Passive Folders

The MFS software module use slightly different methods to perform the same functions on UNIX and Windows systems. The details are described in the following sections.

### 6(a). UNIX

When the application accesses the Active folder and a component file or directory, MFS software module intercepts the operations. Only Write-related operations, such as create (create a file) and mkdir (make a directory), have to be duplicated on both Active and Passive folders. Both operations use the pathname from the input parameter for the file and directory to be created. The create and mkdir operations first use the pathname to identify the Active folder of a mirroring pair from the mirroring pair table, then construct a corresponding pathname for its Passive folder. They then invoke the application interface operation function for the both Active and Passive folders to create new files. The following code sample shows the basic steps:

/* The mnode is the “vnode” mirror files. It contains
* all the information necessary to handle two real vnodes in links
*/
typedef struct mnode {

| struct vnode m_vnode; | | /* vnode for mirror file system */ |
|---|---|---|
| struct mnode | *m_next; | /* Link fro hash chain */ |
| struct vnode | *m_Xvp; | /* pointer to Active vnode */ |
| struct vnode | *m_Yvp; | /* pointer to Passive vnode */ |
| int | state; | /* state of mnode */ |
| } mnode_t; | | |
| static int | | |

mfs_create(vnode_t * mdvp, char *name, struct vattr * va, enum vcexcl excl, int mode,
vnode_t ** vpp, struct cred * cr, int flag)
{

| char | *passive_name; | |
|---|---|---|
| struct mnode | *mp, *mt; | |
| vnode_t | *Active_vp; | /* vnode for active copy */ |
| vnode_t | *Passive_vp; | /* vnode for passive copy */ |
| vnode_t | uvp, nvp; | /* newly created vnodes */ |
| int | err; | |
| /* | | |

```
      * construct the passive name from the matched mirroring pair of mirroring pair
table
    */
    passive_name = get passive_name(name, mirror_table);
```

| | |
|---|---|
| mp = mdvp->v_data; | /* get the mnode from v_data field */ |

| | |
|---|---|
| Active_vp = mp->X_vp; | /* get active vnode */ |

```
    /*
      * send the create operation to the Active folder
    */
    err = VOP_CREATE(Active_vp, name, va, excl, mode, &nvp, cr, flag);
```

| | |
|---|---|
| Passive_vp = mp->Y_vp; | /* get passive vnode */ |
| /* | |

```
      * send the passive_name to the create operation of the Passive folder
      */
    err = VOP_CREATE(Passive_vp, passive_name, va, excl, mode, &uvp, cr, flag);
    /*
      * Store newly created vnodes into mnode structure
    */
  mt = (mnode_t *) kmem_zalloc(sizeof(mnode_t), KM_SLEEP); /* allocate new
mnode */
  mt->m_vnode.v_data = (caddr_t) mt;
```

| | |
|---|---|
| mt->m_Xvp = uvp; | /* save uvp to mnode*/ |
| mt->m_Yvp = nvp; | /* save nvp to mnode*/ |
| /* | |

```
    * Save mnode to mnode list for later use
    */
```

| | |
|---|---|
| Save_mnode(mt); | /* Save mnode */ |
| return(err); | |
| } | |
| MFS_Create Function | |

For the mirroring pair in Table 1, to create a file with pathname /home/John/mfs/project, the name string passed into mfs_create( ) is the pathname of the Active file, /home/john/mfs/project. The passive_name string constructed and returned by the get_passive_name( ) function is /net/TPS/John/mfs/project, which is the file to be created for the Passive file. After the creations are completed, the vnode of both the Active and the Passive files are saved in the super vnode data structure, mnode for later use by other file operations. This is how the MFS links the Active and Passive folders at runtime, using the mirroring pair table and the super vnode data structure mnode. The same logic applies to other write-related operations, such as mkdir (make a directory).

6(a)(1). Sequential Operations

Once the files are created, both copies can be updated by the write operation with the mnode information saved in the mnode list. Both use the vnode's application interface function VOP_WRITE( ) for writing data, as shown in the following example MFS_Seqential_Write( ) operation:

```
static int
MFS_Sequential_Write(vnode_t * mvp,
      struct uio * uiop,
      int ioflag,
```

| | | |
|---|---|---|
| struct cred | * cr) | |
| { | | |
| mnode | mt = mvp->v_data; | /* get mnode from v_data */ |
| vnode_t | *uvp = mt->m_Xvp; | /* vnode for active copy */ |
| vnode_t | *nvp = mt->m_Yvp; | /* vnode for passive copy */ |
| int | err = 0; | |

```
    /*
      * write data to Passive copy
      */
    err = VOP_WRITE(nvp, uiop, ioflag, cr);
    /*
      * write data to Active copy
      */
    err = VOP_WRITE(uvp, uiop, ioflag, cr);
    return (err);
}
MFS_Sequential_Write function
```

In the above MFS_Sequential_Write function, the writes are sequential, start and finish one write operation at a time.

6(a)(2). Parallel and Synchronous Operation

The writes to both Active and Passive copies can be parallel and synchronous, as shown in the following MFS_Parallel_Write function example:

struct write_args {

| | |
|---|---|
| vnode_t | *mvp; |
| struct uio | *uiop; |
| int | ioflag; |
| cred_t | *cr; |
| }; | |
| /* | |

```
  * The Passive thread for writing data to the Passive copy in parallel
  */
void
mfs_write_nfs_thr(caddr_t * w_args)
{
    struct write_args *args = (struct write_args *) w_args;
```

| | |
|---|---|
| vnode_t | *mvp = args->mvp; |
| struct uio | *nfs_uiop = args->uiop; |
| int | nfs_ioflag = args->ioflag; |
| struct cred | *cr = args->cr; |

mnode mt = mvp->v_data; /* get mnode from v_data field */

| | |
|---|---|
| vnode_t | *nvp = mt->m_Yvp; |
| int | n_err = 0; |

```
    /* nfs write */
    n_err = VOP_WRITE(nvp, nfs_uiop, nfs_ioflag, cr);
    if (n_err > 0) {
        PT(WRT, “write: Can't do mvp %p nvp %p n_err %d”
          ,mvp, nvp, n_err);
    }
    mutex_enter(&vtom(mvp)->thr_sync_mx);
    vtom(mvp)->nfs_busy &= ~WRITE_BUSY;
    cv_signal(&(vtom(mvp)->thr_sync_cv));
    mutex_exit(&vtom(mvp)->thr_sync_mx);
}
/*
  * The parallel write operation that creates the Passive thread for writing data to
Passive copy
  * and write data to Active copy in parallel
  */
static int
MFS_Parallel_Write(vnode_t * mvp,
    struct uio * uiop,
    int ioflag,
    struct cred * cr)
{
```

| | | |
|---|---|---|
| mnode | mt = mvp->v_data; | /* get mnode from v_data field */ |
| vnode_t | *uvp = mt->m_Xvp; | /* vnode for Active copy */ |
| vnode_t | *nvp = mt->m_Yvp; | /* vnode for Passive copy */ |
| int | err = 0; | |
| /* | | |

```
      * Create a Passive thread, mfs_write_nfs_thr( ) , for writing data to the Passive
copy
    */
    w_args.mvp = mvp;
    w_arg.mvp = uiop;
    w_args.ioflag = ioflag;
    w_args.cr = cr;
    mvp->v_data->nfs_busy |= WRITE_BUSY;
    if (thread_create(NULL, NULL, mfs_write_nfs_thr, (caddr_t) & w_args, 0, curproc,
TS_RUN, 60)
                        == NULL) {
          mvp->v_data->nfs_busy &= ~WRITE_BUSY;
    }
    /*
      * write data to the Active copy
      */
    err = VOP_WRITE(uvp, uiop, ioflag, cr);
    /*
      * Check and wait until the Passive write thread is complete.
      */
    mutex_enter(&vtom(mvp)->thr_sync_mx);
    while (vtom(mvp)->nfs_busy & WRITE_BUSY) {
          cv_wait(&(vtom(mvp)->thr_sync_cv), &(vtom(mvp)->thr_sync_mx));
    }
    mutex_exit(&vtom(mvp)->thr_sync_mx);
    return (err);
}
MFS_Parallel_Write function
```

In the MFS_Parallel_Write function, the function can either start a new thread (the Passive thread), mfs_write_nfs_thr, or send a signal to wake up a previously created thread, to write data to the Passive copy. The function then waits for both Active and Passive writes to complete before returning to the user application.

Using a separate thread to write the data to the Passive folder has several advantages:

1. The write function can start the Active copy's Write as soon as the Passive thread is created and started, it does not have to wait for the Passive thread to complete writing data to the Passive copy. With two threads running at the same time, one for writing data to the Passive copy and one for writing data to the Active copy, the same data are written in parallel for an increase in overall performance.

2. When writing to Active copy is finished, there are two options on what to do next for the new thread.
a. Wait for the Passive thread to complete the writing data to the Passive copy.

When the Passive thread is finished, control is returned to the application. This is the synchronous write.
b. Return control to the application without waiting for the Passive thread to complete writing data to the Passive copy. This is the asynchronous write described below.
   6(a)(3). Asynchronous Operations

The Write can be asynchronous, as shown below in the MFS_Asynchronous_Write function:

```
static int
MFS_Asynchronous_Write (vnode_t * mvp,
      struct uio * uiop,
      int ioflag,
      struct cred * cr)
{
```

| | | |
|---|---|---|
| mnode | mt = mvp->v_data; | /* get mnode */ |
| vnode_t | *uvp = mt->m_Xvp; | /* vnode for active copy */ |
| vnode_t | *nvp = mt->m_Yvp; | /* vnode for passive copy */ |
| int | err = 0; | |
| /* | | |

```
    * Create a Passive thread, mfs_write_nfs_thr( ), for writing data to Passive copy
    */
    w_args.mvp = mvp;
    w_arg.mvp = uiop;
    w_args.ioflag = ioflag;
    w_args.cr = cr;
    mvp->v_data->nfs_busy |= WRITE_BUSY;
    if (thread_create(NULL, NULL, mfs_write_nfs_thr, (caddr_t) & w_args, 0, curproc,
TS_RUN, 60)
                        == NULL) {
        mvp->v_data->nfs_busy &= ~WRITE_BUSY;
    }
    /*
      * write data to Active copy
      * after writing to Active copy, the mfs_write function return the result to
      * the application without waiting for the writing to Passive copy to be completed
      */
    err = VOP_WRITE(uvp, uiop, ioflag, cr);
    return (err);
}
MFS_Asynchronous_Write function
```

The MFS_Asynchronous_Write function, like the MFS_Parallel_Write function above, can either start a new thread (the Passive thread) for writing data to the Passive copy or send a signal to wake up a previously started thread. The function does not wait for the writing to the Passive copies to complete before returning to the user application. When the Active write is completed, the function returns the result to the user application. When the application receives the return, writing to the Passive copy or copies may be completed or still in process or waiting to be processed.

The write operation methods described above can be applied to all write-related operations, such as create a file, make a directory, write a file, set an attribute, delete a file, and delete a directory.

### 6(b). Windows System

6(b)(1). Setting Up Pre- and Post-Operation

The MFS software module can be implemented as either a legacy file system filter driver or as a mini-file system filter driver. Both types of file system driver filter the file operation, either before or after the normal file operation initiated by user applications. Every file operation of the file system filter driver module, such as create, read, write, delete, and close, can register as a pre-operation callback function, a post-operation callback function, or as both in its configuration structure FLT_OPERATION_REGISTRATION, as shown below:

```
CONST OPERATION_REGISTRATION Callbacks[ ] = {
    { IRP_MJ_CREATE,
            0,
            0,
            MFS_Create_Post_Operation_Callback
        },
        { IRP_MJ_WRITE,
            0,
            MFS_Write_Pre_Operation_Callback,
            0
        },
        { IRP_MJ_CLOSE,
            0,
            MFS_Close_Pre_Operation_Callback,
            0
        },
};
```

The pre-operation callback function is invoked before the normal file operation is executed. The post-operation callback function is invoked after the normal file operation is executed.

6(b)(2). Post-Operation Callback

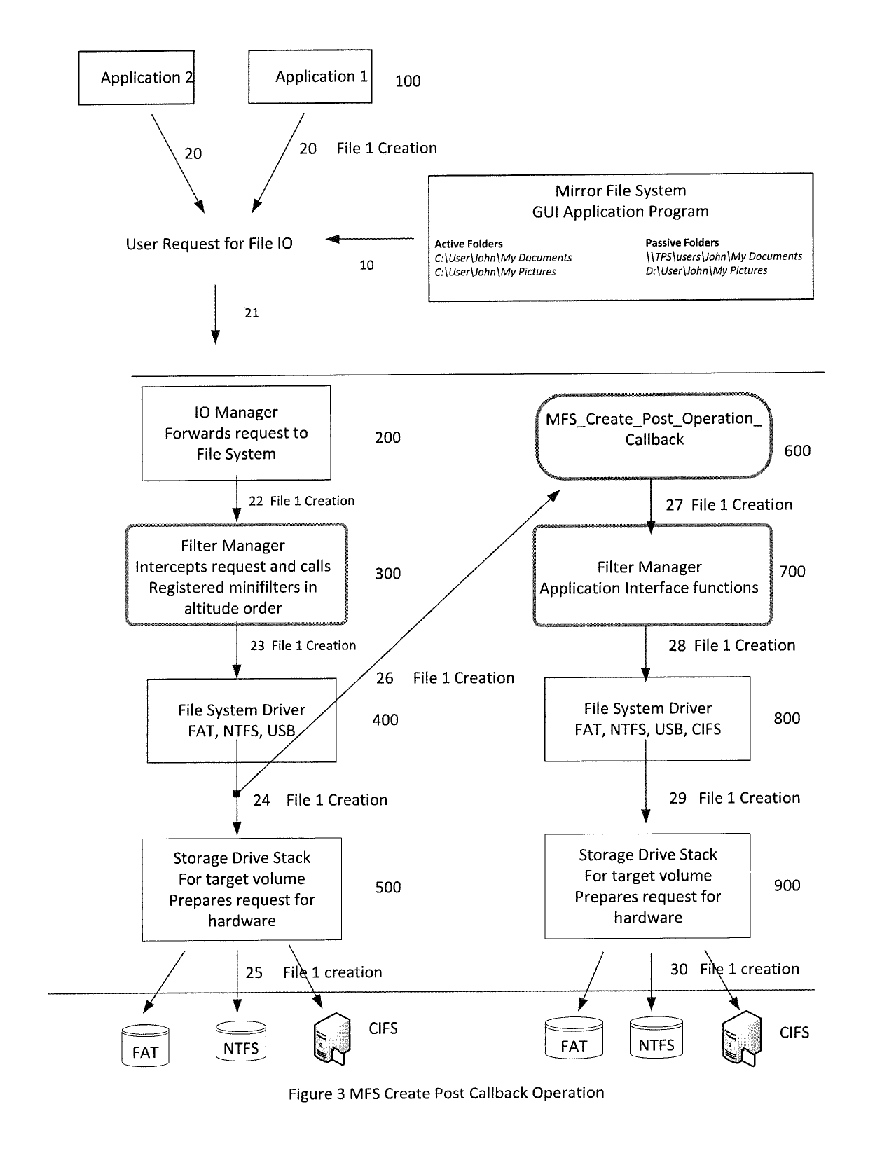

FIG. 3 shows the operations and data flow of a post-operation callback function for the file creation and open operations.
1. The application 1 (100) sends a file Creation operation (20) to IO manager (200).
2. The IO Manager (200) forwards the file 1 Creation operation (22) to Filter Manager (300).
3. The Filter Manager (300) intercepts the file 1 Creation operation (22).
4. The Filter Manager (300) checks the OPERATION_REGISTRATION Callbacks[ ] structure described above and knows the Create callback function is configured as a Post Callback operation, so it forwards the file 1 Creation operation (23) to the File System Driver (400) first.
5. The File System Driver (400) processes the file 1 Creation operation (23) first, then sends the file 1 Creation operation (24) to the Storage Driver (500). When the operation (25) is done, the File System Driver (400) forwards the operation (26) to the Mirror File System's Post Creation operation callback function, MFS_Create_Post_Operation_Callback( ) (600).
6. The MFS_Create_Post_Operation_Callback function (600) calls the Filter Manager's Interface function (700) FltCreateFile( ) to process the file 1 creation operation (27) and sends the file 1 Create operation (28) to File System Driver (800).
7. File System Driver (800) then sends the file 1 Write operation (29) to the designated file system through the Storage Driver (900).
8. The Storage Driver (900) creates a file 1 (30) on a file system and returns the control to the Filter Manager (300), then to application 1 (100).
9. Now there are two identical copies of file 1 created on two different file systems at the same time.
   6(b)(3). Pre-Operation Callback

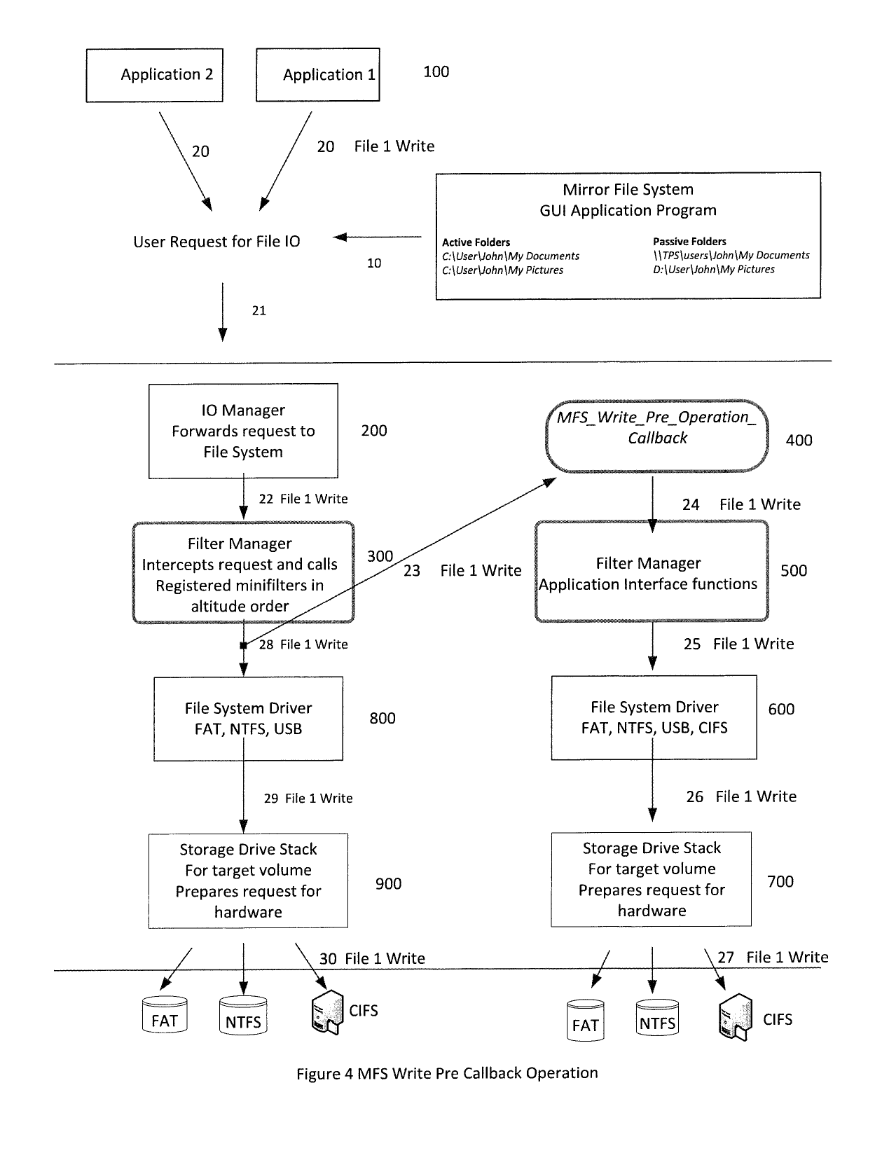

FIG. 4 shows the operations and data flow of a pre-operation callback function for the file write operation.
1. The application 1 (100) sends a file 1 Write operation (20) to IO manager (200).
2. The IO Manager (200) forwards the file 1 Write operation (22) to the Filter Manager (300).
3. The Filter Manager (300) intercepts the file 1 Write operation (22).
4. The Filter Manager (300) checks the OPERATION_REGISTRATION Callbacks[ ] structure described above. It recognizes that the Write call back function is configured as a pre-callback operation, so it forwards the file 1 Write operation (23) to the MFS_Write_Pre_Operation_Callback Function (400).

5. The MFS_Write_Pre_Operation_Callback Function (400) calls the Filter Manager interface function FltWriteFile( ) (500) to processes the file 1 Write operation (24) and sends the file 1 Write operation (25) to File System Driver (600).
6. The File System Driver (600) then sends the file 1 Write operation (26) to the designated file system through the Storage Driver (700).
7. When the File System Driver (700) finishes the file 1 Write operation (27), it returns control to the Filter Manager (300).
8. The Filter Manager (300) forwards the file 1 Write operation (28) to the File System Driver (800).

9. File System Driver (800) sends file 1 Write operation (29) to the designated file system through the Storage Driver (900).
10. The File System Driver (800) finishes the file 1 Write operation (30) and returns control to application 1 (100). Both files on two different file systems are now updated with the same Write operation.
   6(b)(4). Mirroring Operations
   The following example shows how the Create function, registered as a post-create callback function, is implemented to create the file in the Passive folder after creating it in the Active folder.

Create Operation, MFS_Create_Post_Operation_Callback( )
1. Get the path name of the file by calling Filter Manager's interface function FltGetFileNameInformation( ).
2. Parse the path name of the file in Get_Passive_Name( ) function.
3. Check the path name against the mirroring pair table to see if it is located under the Active folder's path. If it is not, then exit.
4. If the file's path name is located under the Active Folder, then construct a path name for the Passive copy and return it as Passive_File_Name.
5. Pass the Passive_File_Name to the Passive folder's Create interface function (FltCreateFileEx ( )) to create a new file or open an existing file under the Passive Folder.
6. If the operation is to create a new file or folder, then it creates the same file or folder under both Active and Passive folders. If the operation is to open an existing file or folder, then it opens it under both Active and the Passive folder.
7. When the Create operation successfully creates or opens a file under the Passive Folder, a file handle for the new file is returned. The file handle is saved either in an MFS software module's data structure similar to monde structure described in [0033] [0034] or in a StreamHandlecontext data structure provided by the mini-filter system, so that other functions, such as Write, Delete, SetInfo, and Close, can retrieve and use it later.
8. Finish the operation and return.

The following code sample shows a simplified version of the MFS software module's Create function implemented as a mini-filter file system post-operation callback function.

FLT_POSTOP_CALLBACK_STATUS
MFS_Create_Post_Operation_Callback (

| _inout | PFLT_CALLBACK_DATA Data, | |
|---|---|---|
| _in | PCFLT_RELATED_OBJECTS | FltObjects, |
| _in | PVOID | CompletionContext, |

| | |
|---|---|
| _in | LT_POST_OPERATION_FLAGS Flags |
| ) | |
| /*++ | |

```
Routine Description:
  This routine receives ALL post-operation callbacks.
It gets the name of file for Active_File_Name
Check if the name of file matches one of Active folders
If not match, exit the function
If it is matched, the Passive_File_Name is generated.
Call mini-filter create function to create/open the Passive_File_Name
Call FltAllocateContext ( ) and FltSetStreamHandleContext( ) to create context handle
and set it on file object for the Active File
Save the Passive_Instance and Passive_File_Handle to streamcontexthandle.
Data - Contains information about the given operation.
FltObjects - Contains pointers to the various objects that are pertinent to this operation.
CompletionContext - This was passed from the pre-operation callback
Flags - Contains information as to why this routine was called.
Return Value: Identifies how processing should continue for this operation
−−*/
{
  FLT_PREOP_CALLBACK_STATUS returnStatus =
FLT_POSTOP_SUCCESS_NO_CALLBACK;
```

| | |
|---|---|
| PFLT_FILE_NAME_INFORMATION | Active_nameInfo = NULL; |
| NTSTATUS | status; |
| OBJECT_ATTRIBUTES | objectAttributes; |
| UNICODE_STRING | Passive_File_Name; |

| | |
|---|---|
| HANDLE | Fhandle = NULL; |

| | |
|---|---|
| PFLT_INSTANCE | Passive_Instance; |
| IO_STATUS_BLOCK | Fstatus; |

PCTX_STREAMHANDLE_CONTEXTstreamHandleContext = NULL;
/*
* Gets File_Name and store it into Active_nameinfo structure
12 */
status = FltGetFileNameInformation( Data, FLT_FILE_NAME_NORMALIZED |

MfsData.NameQueryMethod, &Active_nameInfo );

```
if (!NT_SUCCESS( status )) {
      status = STATUS_UNSUCCESSFUL;
      goto out;
}
/*
* Check if Active_nameinfo matches one of Active Folders. If it is, return
* the Passive_File_Name and the Passive_Instance; if it is not, exit
*/
status = Get_Passive_Name(Active_nameInfo, &Passive_File_Name,
&Passive_Instance);
if (!NT_SUCCESS(status)) {
      goto out;
}
/*
* Initialize the object attributes and create/open the Passive
* file/directory with FltCreateFileEx( ) interface call
*/
InitializeObjectAttributes(&objectAttributes, &Passive_File_Name,
OBJ_KERNEL_HANDLE,
```

NULL, NULL);

status = FltCreateFileEx(MfsData.Filter, Passive_Instance, &Passive_Fhandle,

NULL, DesiredAccess, &objectAttributes, &Fstatus,
(PLARGE_INTEGER) NULL, FileAttributes,
Shared_Access, CreateDisposition, CreateOptions,
NULL, 0L, FCF_Flags);

if (!NT_SUCCESS( status )) {
goto out;
}
/* Allocate a streamHandleContext data structure */
status = FltAllocateContext( MfsData.Filter, FLT_STREAMHANDLE_CONTEXT,

STREAMHANDLE_CONTEXT_SIZE, PagedPool,
&streamHandleContext );

if (!NT_SUCCESS( status )) {
goto out;
}
/*
* set the context we just allocated on the file object
*/
status = FltSetStreamHandleContext( Data->Iopb->TargetInstance,

Data->Iopb->TargetFileObject,
FLT_SET_CONTEXT_REPLACE_IF_EXISTS,
streamHandleContext, NULL );

```
if (!NT_SUCCESS( status )) {
      goto out;
}
/*
* Store Passive_Instance and Passive_Fhandle to streamHandleContext data
* structure
*/
streamHandleContext->Passive_Instance = Passive_Instance;
streamHandleContext->Passive_Fhandle = Passive_Fhandle;
out:
    /*
      * Release the Context and name information structure (if defined)
    */
if (streamHandleContext) {
    FltReleaseContext(streamHandleContext);
}
if (NULL != Active_nameInfo) {
    FltReleaseFileNameInformation( nameInfo );
}
return FLT_POSTOP_FINISHED_PROCESSING;
}
```

6(b)(5). Write, Delete, Close Operations

The following example shows how the Write function, registered as a pre-write callback function, is implemented to write the file in the Passive folder and then write it in the Active folder.

### Write Operation, MFS_Write_Pre_Operation_Callback( )

1. Call FltGetStreamHandleContext( ) to get the passive file handle from the StreamtHandleContext data structure created and saved in the Create/Open function described above. If the file handle was saved into the MFS software module's data structure in the Create/Open function instead of the system provided StreamtHnadleContext data structure, then using a MFS software module-provided function to retrieve the file handle from the MFS data structure.
2. With the passive file handle, a call to ObReferenceObjectByHandle( ) gets the Passive file's file object.
3. Call the mini-filter-supplied interface routine FltWriteFile( ) function to write the data to the Passive file.
4. Once the MFS_Write_Pre_Operation_Callback( ) is done, control returns to the Active folder's Write function, which writes the same data back to the Active file. This is how MFS achieves file replication in Windows.

In this example, the write of the Passive Folder is implemented as a Pre_Operation_callback function. Data is written to the Active and Passive folders sequentially, first to the Passive Folder, then to the Active Folder. If the Write function is implemented as the MFS_Write_Post_Operation_Callback( ) function, then the sequence is reversed, and the data is written to the Active folder first.

Another way to replicate files between Active and Passive folders is to write the files in parallel. In this scenario, the MFS_Write_Pre_Operation_Callback( ) function does not call FltWriteFile( ) routine directly, but instead does one of the following:
a. Start a new thread and let the new thread call the FltWriteFile( ) routine.
b. Send the data or buffer to be written to a system's Work Item Thread, and let the Work Item Thread write the data to the Passive folder.
c. As in the UNIX sample codes above, there are three ways of replicating file:
d. Sequential write
e. Parallel Synchronous Write
f. Asynchronous Write

All other operations, such as Setinfo, Flush Buffer, and Close, work similarly to the Write function described above, replacing the FltWriteFile( ) interface routine with other mini-filter-supplied interface routines according to each function's specific operation. For example, the Setinfo function calls the FltSetInfo( ) routine. Other functions, such as Flush buffer and Close, can also be set up to utilize the Work Item Thread as described above.

The Windows mini-filter-supplied interface routines are equivalent to the Virtual File System (VFS) Interface framework provided by UNIX-like systems as described in U.S. Pat. No. 7,418,439.

Of all the mini-filter pre- and post-operation functions, only the Create function needs to check a file's path to see if it matches Active folders in the mirroring pair table and apply the Create/Open operation to the same file residing under the Passive folder. All other functions use only the file handle created or opened by the Create function. The file handle is stored either in a data structure of the MFS mini-filter software module or in the streamHandleContext data structure provided by the mini-filter system.

```
FLT_PREOP_CALLBACK_STATUS
MFS_Write_Pre_Operation_Callback (
  _inout PFLT_CALLBACK_DATA Data,
  _in PCFLT_RELATED_OBJECTS FltObjects,
  _deref_out_opt PVOID *CompletionContext
  )
/*++
Routine Description:
This routine receives pre-operation write callbacks for the file object that was created in
create function
  1. It gets the StreamhandleContext associated with the file object of
      Active File that was created earlier.
  2. It gets the File Handle and File Object for the Passive File from the
      StreamHandleContext
  3. Finds the data buffer
  4. Call mini-filter Write function FltWriteFile( ) to write data to the
      Passive File
  Data - Contains information about the given operation.
  FltObjects - Contains pointers to the various objects that are pertinent
            to this operation.
  Completion Context - This was passed from the pre-operation callback
  Flags - Contains information as to why this routine was called.
−−− */
{
  FLT_PREOP_CALLBACK_STATUS return Status =
FLT_PREOP_SUCCESS_NO_CALLBACK;
```

| | |
|---|---|
| NTSTATUS | status; |
| PFLT_INSTANCE | Passive_Instance; |
| PFILE_OBJECT | Passive_FileObject; |
| LARGE_INTEGER | ByteOffset; |
| ULONG | Write_Length; |
| FLT_IO_OPERATION_FLAGS | Write_Flags = 0; |
| PVOID | Orig_Buffer, Buffer, New_Buffer = NULL; |

```
  PCTX_STREAMHANDLE_CONTEXTstreamHandleContext = NULL;
  status = FltGetStreamHandleContext(FltObjects->Instance,
```

FltObjects->FileObject,
&streamHandleContext );

```
  if (!NT_SUCCESS( status )) {
    goto out;
  }
  Passive_Instance = streamHandleContext->Passive_Instance;
  Passive_Fhandle = streamHandleContext->Passive_Fhandle;
  ByteOffset = Data->Iopb->Parameters.Write.ByteOffset;
  Write_Length = Data->Iopb->Parameters.Write.Length;
  Buffer = Data->Iopb->Parameters.Write.WriteBuffer;
  status = ObReferenceObjectByHandle(Passive_Fhandle, FILE_ALL_ACCESS,
```

*IoFileObjectType, KernelMode,
&Passive_Fo, NULL);

```
  if (!NT_SUCCESS(status)) {
    goto out;
  }
  if (Data->Iopb->Parameters.Write.MdlAddress != NULL) {
    Buffer = MmGetSystemAddressForMdlSafe( Data->Iopb-
>Parameters.Write.MdlAddress,
```

NormalPagePriority );

```
  if (Buffer == NULL) {
      /*
  /* If we could not get a system address for the users buffer,
  * then we are going to fail this operation.
  */
    Data->IoStatus.Status = STATUS_INSUFFICIENT_RESOURCES;
    Data->IoStatus.Information = 0;
    goto out;
}
status = FltWriteFile(Passive_Instance, Passive_Fo, &ByteOffset,
                Write_Length, Buffer, Write_Flags, &BytesWritten,
                NULL, NULL);
if (!NT_SUCCESS(status)) {
      MFS_Debug(WRITE_PRE,
                “\nWrite_Pre: FAIL (FltWriteFile) status %x File name %wZ”,
                status, &Passive_File_Name);
  }
out:
  ObDereferenceObject(Smb_Fo);
  *CompletionContext = NULL;
  if (streamHandleContext) {
      FltReleaseContext(streamHandleContext);
  }
    return returnStatus;
}
```

While the foregoing is directed to exemplary embodiments, other and further exemplary embodiments can be devised without departing from the basic scope determined by the claims.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A virtual file system which provides mirroring and linking of folders or directories across multiple computers, comprising:
means for selecting a pair of an Active folder or directory and a Passive folder or directory, the Passive folder or directory being mounted on a different mount point than the Active folder or directory;
means for linking the selected Active folder or directory and the selected Passive folder or directory to form a mirroring pair;
means for receiving a user request to update at least one file in the Active folder or directory; and
means for automatically replicating the requested update to the at least one file in the Active folder or directory of the formed mirroring pair to a corresponding file in the Passive folder or directory such that the update to the at least one file in the Active folder or directory is automatically made to the corresponding file in the Passive folder or directory mounted on the different mount point than the Active folder or directory.

2. The virtual file system according to claim 1, wherein the received request to update the at least one file in the Active folder or directory includes a request to create a new file, and
wherein the means for automatically replicating the update creates the same new file in the Passive folder or directory.

3. The virtual file system according to claim 1, wherein the received request to update the at least one file in the Active folder or directory includes a request to modify an existing file in the Active folder or directory, and
wherein the means for automatically replicating the update modifies the corresponding file in the Passive folder or directory.

4. The virtual file system according to claim 1, wherein the means for selecting receives a selection of a pair of an Active folder or directory and a plurality of Passive folders or directories, the plurality of Passive folders or directories each being mounted on a different mount point than the Active folder or directory.

5. The virtual file system according to claim 1, wherein the mirroring pair includes a plurality of mirroring pairs.

6. The virtual file system according to claim 1, wherein the means for linking provides a mirroring pair table having an input path name to the means for automatically replicating, and
the means for automatically replicating uses the input path name to locate the mirroring pair in the Active folder or directory matching the input path name, and construct a corresponding path name from the matching pair for the Passive folder or directory.

7. The virtual file system according to claim 6, wherein when the means for receiving receives a request to one of create and open a file in the Active folder or directory, the means for automatically replicating one of creates and opens a corresponding file in the Passive folder or directory with a super vnode data structure mnode in the UNIX operating system to form a mirroring link.

8. The virtual file system according to claim 7, wherein the means for linking uses the super vnode data structure mnode to link the files in the Active and Passive folders or directories to form a mirroring pair.

9. The virtual file system according to claim 7, wherein when the means for receiving receives a request to perform a write operation on at least one file in the Active folder or directory, the means for linking uses the super vnode data structure mnode to obtain an application interface data structure vnode of copies of the at least one file in the Active and Passive folders or directories of the mirroring pair, and the means for automatically replicating uses the vnode data structure and an application interface write function of the linked files in one of the Active and Passive folders or directories and of the corresponding at least one file in the other one of the Active and Passive folders or directories to write data in response to the request.

10. The virtual file system according to claim 9, wherein the means for automatically replicating writes the at least one file of both the Active and Passive folders or directories sequentially.

11. The virtual file system according to claim 9, wherein the means for automatically replicating writes the at least one file of both the Active and Passive folders or directories in parallel and synchronously.

12. The virtual file system according to claim 9, wherein the means for automatically replicating writes the at least one file of both the Active and Passive folders or directories asynchronously.

13. The virtual file system according to claim 6, wherein when the means for receiving receives a request to one of create and open a file in the Active folder or directory, the means for automatically replicating one of creates and opens a corresponding file in the Passive folder or directory with a streamHandleContext data structure in the Windows operating system to form a mirroring link.

14. The virtual file system according to claim 13, wherein when the means for receiving receives a request to perform a write operation on at least one file in the Active folder or directory, the means for linking uses the streamHandleContext data structure to obtain a file instance and file handle of a corresponding file in the Passive file or directory linked to the Active folder or directory in the mirroring pair, and the means for automatically replicating uses an application interface write function of the linked Passive folder or directory to write data to the corresponding file in the linked Passive file or folder in response to the request.

15. The virtual file system according to claim 14, wherein the means for linking uses the streamHandleContext data structure to obtain the file instance and file handle of the corresponding file in the Passive file or directory one of before and after a write operation is performed on the at least one file in the Active folder or directory in response to the request.

16. The virtual file system according to claim 14, wherein the means for automatically replicating writes the at least one file of both the Active and Passive folders or directories sequentially.

17. The virtual file system according to claim 14, wherein the means for automatically replicating writes the at least one file of both the Active and Passive folders or directories in parallel and synchronously.

18. The virtual file system according to claim 14, wherein the means for automatically replicating writes the at least one file of both the Active and Passive folders or directories asynchronously.
